(19) United States
(12) Patent Application Publication
(10) Pub. No.: US 2014/0222369 A1
(43) Pub. Date: Aug. 7, 2014

(54) SIMPLIFIED METHOD FOR ESTIMATING THE ORIENTATION OF AN OBJECT, AND ATTITUDE SENSOR IMPLEMENTING SUCH A METHOD

(71) Applicants: Bruno Flament, Saint Julien De Ratz (FR); Yanis Caritu, Saint Joseph La Riviere (FR); Gregoire Aujay, Grenoble (FR)

(72) Inventors: Bruno Flament, Saint Julien De Ratz (FR); Yanis Caritu, Saint Joseph La Riviere (FR); Gregoire Aujay, Grenoble (FR)

(73) Assignee: MOVEA, Grenoble (FR)

(21) Appl. No.: 14/124,009

(22) PCT Filed: Jun. 7, 2012
(86) PCT No.: PCT/EP2012/060792

§ 371 Date: Jan. 24, 2014

(30) Foreign Application Priority Data
Jun. 7, 2011 (FR) 1154915

(51) Int. Cl. G01C 9/02

(52) U.S. Cl. CPC G01C 9/02
USPC 702/150

(57) ABSTRACT

A system and method for estimating the orientation of an object in space at the instant k using measurements of the total acceleration (y_{A}), of magnetic field (y_{M}) and of the speed of rotation (y_{G}) of said object in relation to three space axes, comprising a step of preprocessing said measurements (y_{A}, y_{M}, y_{G}) at an instant k so as to detect the existence of a disturbance in said measurements and to compute corrected measurements at the instant k and a step of estimating the orientation (\hat{q}ₖ) at the instant k by an observer on the basis of the corrected measurements (\tilde{y}_{A,k}, \tilde{y}_{M,k}, \tilde{y}_{G,k}) at the instant k obtained from the preprocessing step. The estimation step advantageously uses matrices for transforming the frame of the object into a fixed frame which are applied, in case of disturbance, to a quaternion deduced from the integration of a measurement of speed of rotation composed with a quaternion of orientation computed at the instant k−1.

### CROSS-REFERENCES TO RELATED APPLICATIONS

This application is a national stage application of International Application No. PCT/EP2012/060792, filed Jun. 7, 2012, which claims priority to French Application No. 1154915, filed Jun. 7, 2011, the disclosure of each of which is incorporated by reference in its entirety.

### TECHNICAL FIELD

The present invention pertains to a method for estimating the orientation of an object in space, impressed or not with an inherent acceleration and subjected or not to a magnetic disturbance (unknown variations around a field which is mainly uniform in the close environment and constant over time), and to a device implementing such a method.

### BACKGROUND

Estimation of orientation makes it possible to solve a whole class of problems.

Obtaining of the orientation generally requires the implementation of several modalities of sensors, forming part of a set referred to as a motion capture device, also referred to as an attitude platform.

MEMS (“Micro-Electro-Mechanical Systems” or electromechanical microsystems) sensors can be used to constitute this platform, and they exhibit the advantage of being compact and of reduced cost. The sensor offering such a combination of MEMS sensors is often referred to by the name inertial platform or IMU (Inertial Measurement Unit). An attitude platform is an inertial platform augmented with the processing means required to obtain orientation. The employing of such MEMS sensors makes it possible to envisage the use of attitude platforms in varied sectors of application, notably the biomedical sector, for monitoring the elderly at home, functional re-education, in the sports sector, to analyze the movements of sportsmen, in the automobile, robotics, virtual reality, 3D animation sectors and more generally in any sector in which it is sought to determine or to observe a motion.

However, with respect to non-MEMS sensors (notably conventionally manufactured sensors, not arising from micro-technologies and used for example, in the navigation sector), these MEMS sensors are very inexpensive but have the drawbacks of relatively low performance, and of being noisy and biased.

Currently, several schemes exist for obtaining, on the basis of measurements provided by accelerometers, magnetometers and gyrometers, an estimation of the orientation of the object. There exist notably schemes implementing an observer, which make it possible to fuse two items of information: some originating from the measurements provided by the sensors and some originating from an evolution model, doing so while maintaining a computation time compatible with real-time implementation on relatively powerful processors (PC, Smartphone).

The known schemes implementing an observer rely mainly on the use of a Kalman filter. The advantage of this technique is to allow the fusion of the data while taking account of the quality of the information afforded by the measurements provided by the sensors and of the quality of the model of evolution of the kinetic states. Among the various types of Kalman filter, the Extended Kalman Filter (EKF) is used particularly; the latter is fast and simple to implement, one of its applications to motion capture is notably described in the document “Quaternion-based extended Kalman filter for determination orientation by inertial and magnetic sensing”, SABATINI A. M., IEEE Transactions on Biomedical Engineering, 2006, 53(7).

In addition to the choice of the filter, the quality of the measurements injected into the filter has great importance, and notably the confidence that is accorded to their value.

Indeed, the measurements comprise an informative part directly related to the orientation of the object in motion and a disturbing part whose nature depends on the sensor considered. To first order, this entails the inherent accelerations in respect of the measurements provided by the accelerometers, magnetic disturbances in respect of the measurements delivered by the magnetometer and bias in respect of the gyrometers. It is also necessary to take the measurement noise into consideration. However the latter is conventionally processed in the filter.

Several schemes exist for processing disturbances. It is notably possible to disregard disturbed measurements, but in the case where the measurements of several sensors simultaneously exhibit a disturbance, the observer no longer has enough information to propose a correct estimation of the orientation. It is also possible to include a representation of the disturbances in the vector and the state model of the Kalman filter so as to estimate them jointly with the parameters of the attitude of the solid. However, the joint estimation of the disturbances and of the orientation turns out to be tricky on account of a lack of observability. It furthermore requires the adjustment of a large number of parameters, thereby complicating its implementation.

These drawbacks have been overcome by the international patent application published under WO2010/007160, whose applicant is co-owner, which offers a method for estimating orientation providing a precise estimation of the orientation, in the presence or otherwise of inherent accelerations and magnetic disturbances, doing so in a simplified manner relative to existing methods. The previously stated aim is achieved by a method for estimating orientation on the basis of measurements in relation to the three space axes of the acceleration, of the magnetic field and of the speed of rotation, comprising:
a step of preprocessing these measurements so as to detect the existence of a disturbance and to estimate undisturbed measurements, and
a step of estimating the orientation on the basis of the values of measurements arising from the preprocessing step.

This method presents the drawback however of requiring the use of significant computational power which is not available in a microcontroller.

### SUMMARY OF THE INVENTION

In an embodiment, it is the aim of the present invention to afford a method for estimating the attitude parameters of a solid in motion, instrumented by sensors of accelerometer, gyrometer and magnetometer type, which replaces most of the Kalman filter computation steps by direct consideration of measurements of said sensors, which measurements are corrected or uncorrected, depending on whether disturbances are or are not detected, in the state vector.

For this purpose, an embodiment of the present invention relates to a method for estimating the orientation of an object in space at an instant k using at least one measurement of at least one physical field substantially uniform over time and in space and measurements of the speed of rotation of said object in relation to three space axes, said method comprising a first step of detecting the presence of disturbances in the measurements of said at least one physical field and a second step of computing a quaternion of orientation of said object in space deduced from at least one representation of the measurements of said at least one physical field as output by the first step, wherein, when as output of said first step is detected a disturbance of said at least one measurement, said disturbed measurement as output by the first step is combined as input to the second step with a quaternion of orientation of said object computed as output by a third step of integrating a corrected output of the measurement of speed of rotation of the object on the basis of a quaternion of orientation of said object as output by the second step at the instant k−1.

Advantageously, the at least one physical field is the Earth's gravity.

Advantageously, the at least one physical field is the Earth's magnetic field.

Advantageously, the method of the invention uses measurements of at least two physical fields, the Earth's gravity and the Earth's magnetic field.

Advantageously, the method of the invention uses measurements of a single physical field and values of a synthetic field that are constructed on the basis of said lone physical field, said synthetic field being defined such that it has at least one component orthogonal to said physical field and that its vector product with said physical field is non-zero.

Advantageously, said physical field is the gravity G0 and said synthetic field is a vector consisting of a linear combination of said gravity G0 and of a non-zero vector chosen in a plane orthogonal to G0.

Advantageously, said physical field is the Earth's magnetic field H0 and said synthetic field is a vector consisting of a linear combination of said Earth's magnetic field H0 and of a non-zero vector chosen in a plane orthogonal to H0.

Advantageously, the method of an embodiment of the invention furthermore comprises in the first step, a sub-step of correcting the speed of rotation consisting in deducting from the measurements of said speed of rotation a mean bias determined during a step of position at rest and in substituting it with a corrected speed of rotation.

Advantageously, the first step of detecting a disturbance in the measurements of said at least one field consists in determining whether the difference of the norm of the measurements of said at least one field and of their reference values is greater than a chosen threshold value.

Advantageously, the second step of computing a quaternion of orientation of said object is performed by composition of at least two measurements of physical fields as output by the first step and uses an algorithm of TRIAD type.

Advantageously, the second step of computing a quaternion of orientation of said object is performed by composition of measurements of more than two measurements of physical fields as output by the first step and uses an algorithm of QUEST type.

Advantageously, the third step of integrating a corrected output of the measurement of speed of the object on the basis of a quaternion of orientation of said object as output by the second step at the instant k−1 is performed by solving the differential equation:

$${}_{G}^{L ( t )} \dot{\overline{q}} = \frac{1}{2} [ \begin{matrix}ω \\ 0\end{matrix} ] ⊗ {}_{G}^{L ( t )} \overline{q}$$

Advantageously, the estimated quaternion of the object as output by the second step is normalized.

An embodiment of the present invention also relates to an attitude platform for an object in space comprising means for measuring at least one physical field and the speed of rotation of said object in relation to three space axes, said platform comprising a first module for preprocessing at the instant k so as to detect the presence of the at least one physical field and a second module for computing a quaternion of orientation of at least one representation of the orientation of said object computed on the basis of at least one representation of the measurements of said at least one physical field as output by the first module, wherein, when as output of said first module is detected a disturbance of said at least one measurement said disturbed measurement as output by the first module is replaced as input to the second module by a measurement combined with a quaternion of orientation of said object computed as output by a third module for integrating a corrected output of the measurement of speed of the object on the basis of a quaternion of orientation of said object as output by the second module at the instant k−1.

The present invention is usable for all combinations of sensors comprising:
at least one sensor able to return information representative of the angular velocity (for example: a gyroscope, a pair of accelerometers separated by a lever arm, etc.)
and at least one sensor able to return information representative of a physical field P₀ which is mainly uniform and constant over time and in space

The device of an embodiment of the invention will preferably be composed of a gyroscope, an accelerometer (able to measure the Earth's gravitational field G₀) and a magnetometer (able to measure the Earth's magnetic field H₀).

The invention presents the advantage of allowing estimation of the true acceleration and of the true magnetic disturbances:

AcceleroMeasurements=OrientationMatrix*(TrueAcc−Go(0,0,1))

TrueAcc=Transpose(OrientationMatrix)*AcceleroMeasurements+Go(0,0,1).

In an embodiment, the invention furthermore presents the advantage of allowing the choice of the sensors whose measurements are to be favored as a function of various cases of employment. Notably, in the case where a disturbance is detected on the accelerometer or the magnetometer, the outputs of the other sensor are favored and a suitable processing is carried out which is compatible with a low computation capacity and with a low memory capacity.

In certain of its embodiments, the invention can advantageously be implemented by envisaging a window for analysis of a duration making it possible to adequately test the occurrence of disturbance.

### BRIEF DESCRIPTION OF THE DRAWINGS

The present invention will be better understood with the aid of the description which follows and of the appended drawings, in which:

FIG. 1 represents a functional architecture for implementing the method according to the prior art for the sample k;

FIG. 2 represents a functional architecture for implementing the method of the invention for the sample k, in one of its embodiments;

FIG. 2b represents a variant of the functional architecture of FIG. 2, in certain of its embodiments;

FIG. 3 represents a detail of FIG. 2b;

FIGS. 4a to 4g represent measurements carried out on an accelerometer during the implementation of the invention in the architecture of FIG. 2b;

FIGS. 5a to 5f represent measurements carried out on a magnetometer during the implementation of the invention in the architecture of FIG. 2b.

### DETAILED DESCRIPTION

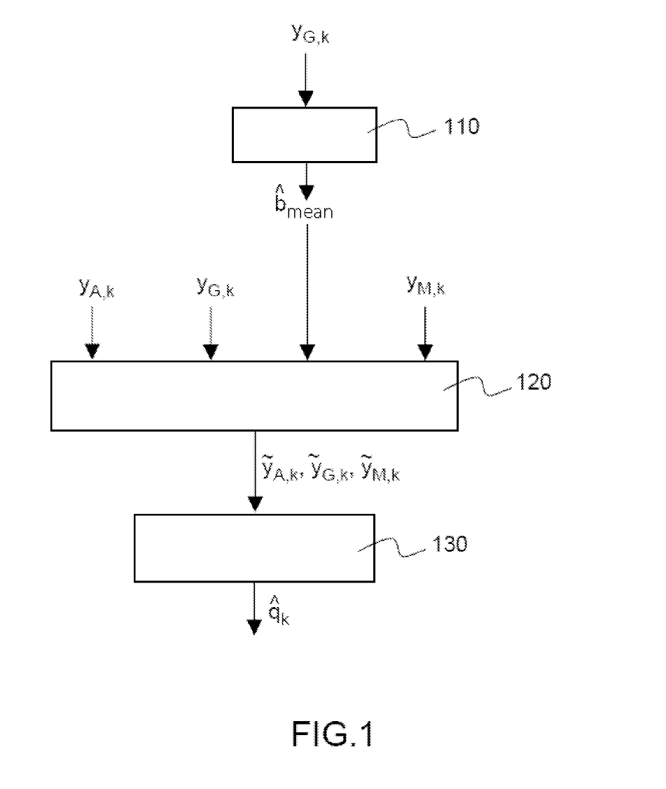

FIG. 1 represents a functional architecture for implementing the method according to the prior art for the sample k.

This figure illustrates the implementation of the method disclosed by the international application published under WO2010/007160, the notation and certain steps of which are used within the framework of the implementation of the present invention.

It is desired to obtain the orientation of an object moving in space, for example the orientation of a person (if the sensor is located on the chest or on the waist) or of a segment of a person (if the sensor is located on the body part of interest). Accordingly, use is made of an attitude platform comprising sensors able to provide measurements of the total acceleration, of magnetic field and of the speed of rotation in relation to the three space axes. The sensors are advantageously MEMS sensors offering a reduced cost price and limited bulk.

This method of the prior art comprises a step 110 of initializing the attitude platform, a step 120 of preprocessing the measurements provided by the sensors and a third step 130 of processing by an observer, of Extended Kalman Filter or EKF type.

According to the invention, it is possible to diversify the sensors; for example, for the measurement of the acceleration, the system can consist of a tri-axis accelerometer or of three mono-axis accelerometers providing a measurement on each of the axes.

Our invention describes mainly the method using the three modalities of measurements mentioned above but the reasoning is the same for another trio of sensors.

The minimum properties of the device must, in a favored manner, be as follows:
A measurement sensor y_{G} with at least one sensitive axis, able to return a measurement related to the angular velocity ω by an identifiable model;

—A measurement sensor y_{A} with at least one sensitive axis able to return a measurement of a reference field G₀ fixed in the reference frame and identifiable at a given moment, to which may be added a variation a of the same nature as G₀ but unknown a priori;

Preferably, these sensors are respectively: a gyrometer and an accelerometer or a magnetometer. It should be noted that in the method relying on the above device, a step of constructing a measurement of a synthetic physical field orthogonal to G₀ will then be carried out.

A preferable device which is slightly more expensive but of higher performance possesses the following minimum properties:
A measurement sensor y_{G} with at least one sensitive axis, able to return a measurement related to the angular velocity ω by an identifiable model;
A measurement sensor y_{A} with at least one sensitive axis able to return a measurement of a reference field G₀ fixed in the reference frame and identifiable at a given moment, to which may be added a variation a of the same nature as G₀ but unknown a priori;
A measurement sensor y_{M} with at least one measurement axis able to return a measurement of a reference field H₀ fixed in the reference frame and identifiable at a given moment, to which may be added a variation m of the same nature as G₀ but unknown a priori.

Preferably, these sensors are respectively: a gyrometer, an accelerometer and a magnetometer.

It should be noted that these three types of sensors provide complementary information with a view to a better estimation of the orientation, notably when using tri-axial sensors:
The gyrometer, if it is integrated, affords angular information with three degrees of freedom, but relatively, that is to say with a propensity to drifting if said gyrometer is used alone;
The accelerometer affords two absolute angular degrees of freedom (roll and pitch), which are accessible statically if said accelerometer is used alone;
The magnetometer affords two angular degrees of freedom (including yaw), which are accessible in a magnetically undisturbed context if said magnetometer is used alone.

It is possible to generalize the present invention which remains valid for any axial sensor able to measure a uniform direction in space to replace the physical field measurement sensors providing the gyroscope with extra information.

One way is to think of the measurements of DOA (Direction of Arrival) for any type of electromagnetic waves, in particular the wavefields emitted by the beacons that mobile telephony operators use to mesh the network coverage space, or photoelectric cells according to modalities disclosed by the European patent application published under the No. EP1984696. This may also involve a device using plane ultrasound waves originating from a distant source and whose direction is measured and plays the role of the physical field.

One of the advantages of the accelerometer-magnetometer pair is the capacity of each of these two sensors to provide these two complementary DOFs. It is however very possible to use other vector sensors which complement one another in the same manner. The accelerometer is however necessary if it is desired to estimate the inherent acceleration, the linear velocity or the position etc.

For the magnetic field measurements, the favored sensors can be a tri-axis magnetometer or three mono-axis magnetometers.

For the measurement of the speed of rotation, the favored sensors can be three mono-axis gyrometers, advantageously two bi-axis gyrometers or one tri-axis gyrometer.

The tri-axes may or may not be aligned, in the latter case the relative orientation between the axes must be known.

In the subsequent description, for purposes of simplicity, we shall refer to the accelerometer or accelerometers, as an accelerometer, the magnetometer or magnetometers as a magnetometer and the gyrometer or gyrometers as a gyrometer. These sensors are attached to the object whose orientation it is desired to ascertain.

We have the measurements Y, that we model in vector notation by:

$$\{ \begin{matrix}{Y}_{A} = {}_{G}^{L} R ( {}_{}^{G}{G}{}_{0}^{} + {}^{G} a ) + {v}_{A} \\ {Y}_{M} = {}_{G}^{L} R ( {}_{}^{G}{H}{}_{0}^{} + {}^{G} h ) + {v}_{M} \\ {Y}_{G} = {}^{L} ω + b + {v}_{G}\end{matrix} \qquad ( 1 )$$

Where the prefixes L and G specify whether the vector is expressed in the fixed global frame {G} or in the moving local frame {L} with:
Y_{A}: tri-axis measurement of the total acceleration, provided by the accelerometer,
Y_{M}: tri-axis measurement of the magnetic field, provided by the magnetometer,
Y_{G}: tri-axis measurement of the speed of rotation, provided by the gyrometer, and also denoted ω
_{G}^{L}R: is the switching matrix for going from the global frame to the local frame (rotation matrix),
G₀: Earth's gravity field (3×1 vector), expressed in the fixed frame in general, i.e. (0,0,1),
H₀: Earth's magnetic field (3×1 vector), also expressed in the fixed frame in general, i.e. (0.5; 0;

$$\frac{\sqrt{3}}{2} )$$

ω: angular velocity,
a: inherent accelerations or disturbing variations of acceleration,
H: magnetic disturbances,
b: bias of the gyrometer,
v_{A}: accelerometer measurement noise,
v_{M}: magnetometer measurement noise,
v_{G}: gyrometer measurement noise.

The orientation is estimated with respect to a reference frame, fully defined by giving the vectors G₀ and H₀. For example, the geocentric frame is defined by the vectors G₀ (0; 0; 1) and H₀ (0.5; 0;

$$\frac{\sqrt{3}}{2} )$$

For purposes of simplicity, we will not distinguish the measurements in relation to the three directions in space.

As is clearly apparent in view of the mathematical definition of the measurements (see for example: Harold D. Black. A passive system for determining the attitude of a satellite. American Institute of Aeronautics and Astronautics Journal, 2(7):1350-1351, July 1964), each of these measurements comprises respectively a first part “RG_{O}”, “R.H_{O}” and ω, which contains the information making it possible to obtain an estimation of the orientation, a second part a, d and b which represents the possible disturbances that may appear, randomly in the measurements, and finally a third part v_{A}, v_{M}, v_{G} representing the measurement noise at the level of each sensor.

The notation conventions used hereinafter in the developments are firstly defined hereinbelow.

Quaternions are used in a preferential manner for the representation of quantities. Several notations of quaternions exist. The academic notation is that of Hamilton. We will rather use that which favors the multiplications of quaternions in a natural order. It was proposed by the JPL (Jet Propulsion Laboratory) in 1999 (see for example: W. G. Breckenridge, “Quaternions—Proposed Standard Conventions,” JPL, Tech. Rep. INTEROFFICE MEMORANDUM. IOM 343-79-1199, 1999;

Nikolas Trawny and Stergios I. Roumeliotis, “Indirect Kalman Filter for 3D Attitude Estimation”, A Tutorial for Quaternion Algebra, Department of Computer Science & Engineering, University of Minnesota. Technical Report, 2005-002, Rev. 57, March 2005).

According to this notation, the quaternion will be denoted q̅ and defined as follows:

$$\overline{q} = \underbrace{{q}_{4}}_{{real}_{part}} + \underbrace{{q}_{1} i + {q}_{2} j + {q}_{3} k}_{{imaginary}_{part}} \qquad ( 2 )$$

In matrix notation, it is also possible to write:

$$\overline{q} = [ \begin{matrix}q \\ {q}_{4}\end{matrix} ] = {[ \begin{matrix}{q}_{1} & {q}_{2} & {q}_{3} & {q}_{4}\end{matrix} ]}^{T} \qquad ( 3 )$$

If q and q₄ fulfill the conditions hereinafter, and this will be the case for the whole of our account, q̅ is termed the unit quaternion. It then represents a rotation of angle θ about the unit vector \hat{k}:

$$q = [ \begin{matrix}{k}_{x} sin ( θ / 2 ) \\ {k}_{y} sin ( θ / 2 ) \\ {k}_{z} sin ( θ / 2 )\end{matrix} ] = \hat{k} sin ( θ / 2 ) and {q}_{4} = cos ( θ / 2 ) \qquad ( 4 )$$

A vector p in space (3 coordinates) can be represented in the form of a quaternion:

$$\overline{p} = [ \begin{matrix}p \\ 0\end{matrix} ] \qquad ( 5 )$$

We will use the following notation to specify the reference frames in which the vectors are expressed:

^{L}p=_{G}^{L}C( q̅)^{G}p (6)

Where:
q̅=_{G}^{L} q̅
_{G}^{L}C( q̅) is a rotation matrix (3×3) which expresses the global frame {G} in the local frame {L}.

With this notation, it is possible to switch from the coordinate system of the local frame (moving sensor frame) to the global frame (fixed frame) and vice versa through the following expression:

^{L} p̅=_{G}^{L} q̅ [symbol] ^{G} p̅ [symbol] _{G}^{L} q̅⁻¹ (7)

We process angular velocities of the local coordinate system {L} commonly that of the sensor in motion with respect to the global frame {G}, the time derivative of the quaternion is expressed on the basis of the general expression (see Trawny and Roumeliotis, reference cited hereinabove):

$${}_{G}^{L} {q}^{\dot{\_}} ( t ) = {lim}_{Δ t -> 0} \frac{1}{Δ t} ( {}_{G}^{L ( t + Δ t )} \overline{q} - {}_{G}^{L ( t + Δ t )} \overline{q} ( t ) ) \qquad ( 8 )$$

Now:

_{G}^{L}(t+Δt) q̅=_{L}(t)^{L}(t+Δt) q̅ [symbol] _{G}^{L}(t) q̅ (9)

Where the rotation from {L(t)} to {L(t+Δt)} is expressed in the following manner:

$${}_{L ( t )}^{L ( t + Δ t )} \overline{q} = [ \begin{matrix}\hat{k} sin ( θ / 2 ) \\ cos ( θ / 2 )\end{matrix} ] {\approx }_{Δ t \approx 0} [ \begin{matrix}\hat{k} \cdot θ / 2 \\ 1\end{matrix} ] = [ \begin{matrix}\frac{1}{2} δθ \\ 1\end{matrix} ] \qquad ( 10 )$$

The vector N has the sameδθ direction as the axis of the rotation that switches from {L(t)} to {L(t+Δt)} and has a magnitude equal to the angle of rotation. Now, the definition of the angular velocity gives us:

$$ω = {lim}_{Δ t -> 0} \frac{δ θ}{Δ t} \qquad ( 11 )$$

Therefore, according to expressions (8), (9), (10) and (11):

$${}_{G}^{L ( t )} {q}^{\dot{\_}} = \frac{1}{2} [ \begin{matrix}ω \\ 0\end{matrix} ] ⊗ {}_{G}^{L ( t )} \overline{q} \qquad ( 12 )$$

To estimate the angles on the basis of the gyro measurements ω we will need to integrate a quaternion. Integrating a quaternion is equivalent to solving the 1^{st}-order differential equation hereinabove. In Trawny and Roumeliotis, (reference cited hereinabove), the solution is found to order 0:

$${}_{G}^{L} \overline{q} ( {t}_{k + 1} ) = ( cos ( \frac{\vert ω \vert}{2} Δ t ) + \frac{1}{\vert ω \vert} sin ( \frac{\vert ω \vert}{2} Δ t ) \cdot Ω ( ω ) ) {}_{G}^{L} \overline{q} ( {t}_{k} ) \qquad ( 13 )$$

### Where

$$Ω ( ω ) = [ \begin{matrix}0 & {ω}_{z} & - {ω}_{y} & {ω}_{x} \\ - {ω}_{z} & 0 & {ω}_{x} & {ω}_{y} \\ {ω}_{y} & - {ω}_{x} & 0 & {ω}_{z} \\ - {ω}_{x} & - {ω}_{y} & - {ω}_{z} & 0\end{matrix} ] \qquad ( 14 )$$

(13) has a more stable expression when ω→0:

$${lim}_{\vert ω \vert -> 0} ( {}_{G}^{L} \overline{q} ( {t}_{k + 1} ) ) = ( {I}_{4 \times 4} + \frac{Δ t}{2} Ω ( ω ) ) {}_{G}^{L} \overline{q} ( {t}_{k} ) \qquad ( 15 )$$

We note that (13) can also be rewritten:

$${}_{G}^{L} \overline{q} ( {t}_{k + 1} ) = [ \begin{matrix}\frac{ω}{\vert ω \vert} \cdot sin ( \frac{\vert ω \vert}{2} Δ t ) \\ cos ( \frac{\vert ω \vert}{2} Δ t )\end{matrix} ] ⊗ {}_{G}^{L} \overline{q} ( {t}_{k} ) \qquad ( 16 )$$

where it is seen that the solution at tₖ₊₁ is none other than the rotation of the previous frame taken at tₖ in relation to an axis defined by ω with an angle of rotation equal to |ω|Δt, this corresponding to the assumption to order 0 which hypothesizes that ω is constant between tₖ and tₖ₊₁. A person skilled in the art of motion capture will be able to consult the literature, notably Trawny and Roumeliotis, (reference cited hereinabove) to establish the solutions to higher orders (constant angular acceleration, constant angular jerk, etc.).

The reference framework for the notations making it possible to describe the present invention is now laid down.

We can now describe the steps of the processing method with the aid of the previously defined notations.

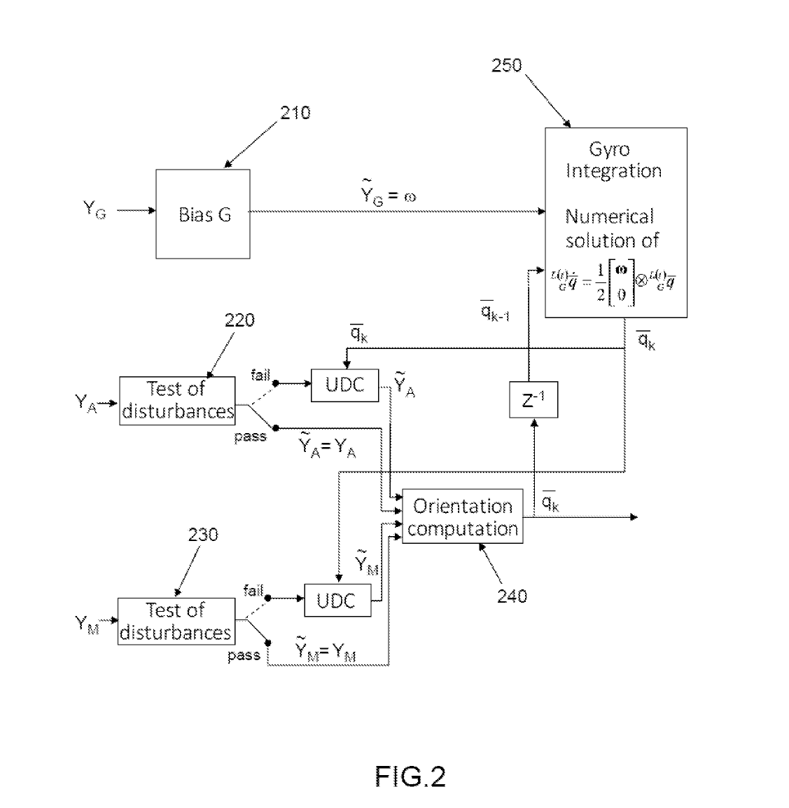

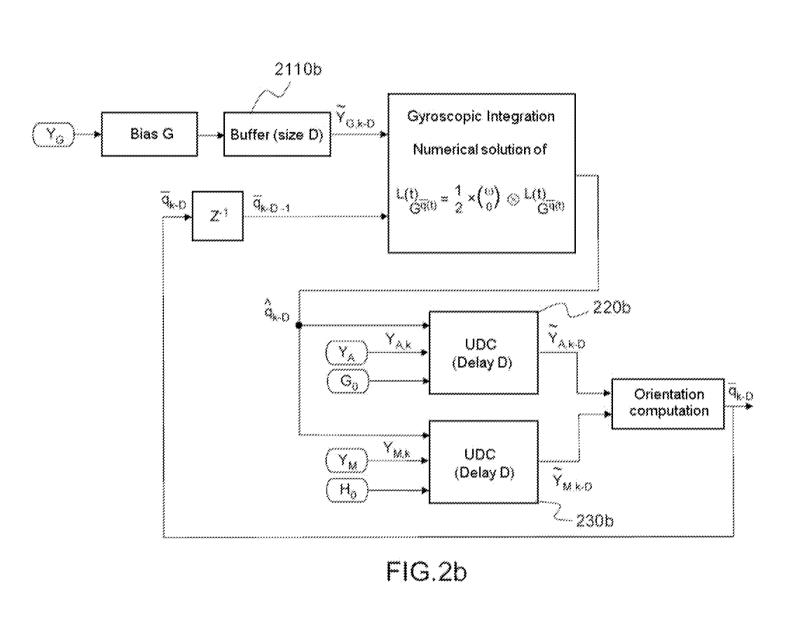

FIG. 2 represents a functional architecture for implementing the method of the invention for the sample k, in one of its embodiments.

With the same namings of variables as in the Black reference cited above, it is possible to write the measurement models for the various sensors of the device considered (two sensors of fields G₀ and H₀ that are uniform in the absolute frame, for example an accelerometer and a magnetometer, and a sensor representative of the angular velocity, for example a gyrometer) in the form:

$$( \begin{matrix}{Y}_{G} \\ {Y}_{A} \\ {Y}_{M}\end{matrix} ) = ( \begin{matrix}ω + b \\ \overline{q} ⊗ ( {G}_{0} + a ) ⊗ {\overline{q}}^{- 1} \\ \overline{q} ⊗ ( {H}_{0} + h ) ⊗ {\overline{q}}^{- 1}\end{matrix} ) + ( \begin{matrix}{v}_{G} \\ {v}_{A} \\ {v}_{M}\end{matrix} ) \qquad ( 17 )$$

At t₀, it may be considered that the device is in its neutral or reference position and that it is stationary, so that only the fields G₀ and H₀ are measured, with no acceleration a or disturbance h. The sensor frame is merged with the fixed reference frame and, if sensor noise is neglected:

$$( \begin{matrix}{Y}_{G} ( {t}_{0} ) \\ {Y}_{A} ( {t}_{0} ) \\ {Y}_{M} ( {t}_{0} )\end{matrix} ) = ( \begin{matrix}0 \\ {}_{ }^{G}{G}{}_{0}^{ } \\ {}_{ }^{G}{H}{}_{0}^{ }\end{matrix} ) \qquad ( 18 )$$

This equation shows that it is possible to record by measurement the reference fields G₀ and H₀ at t₀ or, if so desired, whenever a and h are zero.

At t>t₀, let us consider that the device has left its neutral position and is moving off.

The general principle of the processing operations according to the invention is as follows:

The measurements are preprocessed either to eliminate the bias (case of the gyrometer), or to detect the disturbances by which they may possibly be affected; these preprocessing operations are similar to those performed according to the prior art; they are indicated in FIG. 2 by the references 210, 220 and 230;
When the measurements output by the accelerometer and by the magnetometer (or by other sensors fulfilling the same functions, as indicated above) are not disturbed, the orientation is provided by a conventional algorithm represented in FIG. 2 by the reference 240;
When one of the measurements output by one of these sensors is disturbed, it is replaced as input to the algorithm for computing the orientation by a measurement reconstructed on the basis of the quaternion computed by an algorithm referenced 250 in FIG. 2, to which are provided the angular velocity output by the gyrometer and the quaternion output by the computation algorithm 240 at the instant k−1.

The measurements are therefore firstly preprocessed:
The processing 210 makes it possible to filter the gyrometer so as to eliminate its bias b. This processing consists in evaluating its variance over a sliding window of a chosen duration T (for example 1 second). If the variance remains below a certain threshold, it may be considered that the gyrometer does not undergo any angular velocity. The average is established over the window, thereby giving an estimate of the bias b on each measurement axis.
210 is therefore expressed as follows:

if var(Y_{G}(t_{k-T+1}), . . . ,Y_{G}(tₖ))≦α_{G} [symbol] \tilde{Y}_{G}(tₖ)=Y_{G}(tₖ)− [symbol] Y_{G} [symbol] _{T}

if var(Y_{G}(t_{k-T+1}), . . . ,Y_{G}(tₖ))>α_{G} [symbol] \tilde{Y}_{G}(tₖ)=Y_{G}(tₖ) (19)
this method is preferentially applied upon initialization, taking care that the moving object observes a stable period of greater than T; nonetheless, the bias can be computed permanently knowing that it will be refreshed only if the threshold conditions (19) are complied with; in (19), the test is performed for each axis of the gyroscope, thereby making it possible optionally to correct an axis when no rotatory motion is observed by said axis; nonetheless, it is possible to replace Y_{G} by its norm for this test of the variance; in this case, it is necessary that the moving object observes an absolute (complete) stable position so that the corrections apply (consequently on all the axes); the notation tₖ will sometimes be interchanged with the notation k to refer to the instant.
The processing 220 makes it possible to test the measurements of the accelerometer (or of an equivalent sensor of uniform field); the actual test of the existence or otherwise of an inherent acceleration is applied. Accordingly, the norm of the measurement Y_{A,k} is compared with the norm of the gravitational field (recall that we work in terms of a multiple of G₀), a comparison with respect to 1 is therefore made: if |∥Y_{A,k}∥−1|<α_{A},

Advantageously, in the case of a positive test, the following test is added: |\hat{α}ₖ₋₁|<β_{A}

Comparison of the norm of the inherent acceleration estimated at the instant k−1, \hat{α}ₖ₋₁, with β_{A}, makes it possible advantageously to exclude particular cases for which the first test would not suffice. Indeed, it is considered that if at the instant k−1 the inherent acceleration has a high value, i.e. greater than β_{A}, it is rather improbable that at the instant k the inherent acceleration is less than β_{A}. α_{A} and β_{A} are for example equal to 0.04 and 0.2 respectively.

This second test therefore improves the precision of the estimation of the undisturbed measurement \tilde{Y}_{A,k} and therefore of the estimation of the orientation.

→ If the tests hereinabove are positive, it is then decided that the inherent acceleration \hat{α}ₖ is zero at the instant k.

The reasoning is the same for the filter 230 relating to the magnetometer (or another equivalent sensor of uniform field).

The sequel consists in constructing undisturbed measurements:
If the above tests 220 or 230 are positive, there are no disturbances:

if test₂₂₀>0 [symbol] \tilde{Y}_{A,k}=Y_{A}

if test₂₃₀>0 [symbol] \tilde{Y}_{M,k}=Y_{M} (20)
If the above tests 220 and/or 230 are negative, there are disturbances, an artificial measurement is then constructed, via the UDC (UnDisturbed Construction) filter, based on the reference field or fields and on the quaternion estimated at the same instant by the filter 250, whose manner of operation is described further on. The construction of this undisturbed measurement is expressed as follows (valid for Y_{A} and Y_{M}):

\tilde{Y}ₖ= q̅ₖ [symbol] G₀ [symbol] q̅ₖ⁻¹ (21)

The equation hereinabove applies for \tilde{Y}_{Ak} as much as for \tilde{Y}_{Mk}, with the same formalism (using H₀ instead of G₀).

The measurements \tilde{Y}_{Ak} and \tilde{Y}_{Mk}, are thereafter input directly to a traditional orientation computation algorithm of TRIAD (TRI-axial Attitude Determination) type for example (cf: http://en.wikipedia.org/wiki/Triad Method

or 1964 publication by Harold Black already cited). This algorithm makes it possible to estimate a rotation quaternion on the basis of the measurement of the two reference directions provided by the data \tilde{Y}_{Ak} and \tilde{Y}_{Mk}. But any other algorithm making it possible to compute the orientation of an object in a reference frame on the basis of its position with respect to the Earth's gravitational field and magnetic field vectors (or of any other uniform field) can replace the TRIAD algorithm. In particular, in the case of more than two sensors, an algorithm of QUEST (Quaternion ESTimator) type, described notably in the publication http://www.dept.aoe.vt.edu/˜cdhall/courses/aoe4140/attde.pdf and, by comparison with TRIAD in http://www.malcolmdshuster.com/comm 1981a J TRIAD-QUEST.pdf

It is also possible to use other algorithms fulfilling the same technical function, for example a gradient descent algorithm such as that disclosed by the international patent application published under the number WO03085357.

The resulting quaternion q̅ₖ is the response of our system for providing the orientation of the device.

This estimation q̅ₖ is thereafter reintroduced into the integration system 250. This processing makes it possible to consider the current estimated attitude q̅ₖ and to update at the instant k+1 by virtue of the gyrometer angular velocity measurement and the elementary rotation which stems therefrom between k and k+1. According to (16), the new quaternion is given by:

$${}_{G}^{L} \overline{q} ( {t}_{k + 1} ) = [ \begin{matrix}\frac{ω}{\vert ω \vert} \cdot sin ( \frac{\vert ω \vert}{2} Δ t ) \\ cos ( \frac{\vert ω \vert}{2} Δ t )\end{matrix} ] ⊗ {}_{G}^{L} \overline{q} ( {t}_{k} ) \qquad ( 22 )$$

FIG. 2b represents a variant of the functional architecture of FIG. 2, in certain of its embodiments.

In this variant, a buffer 2110b which creates a time window of duration D intended to optimize the function for testing occurrence of the disturbances of the accelerometer and of the magnetometer is introduced between the module for computing the bias of the gyrometer 210 (or debiasing module) and the module for integration of the gyrometer 250.

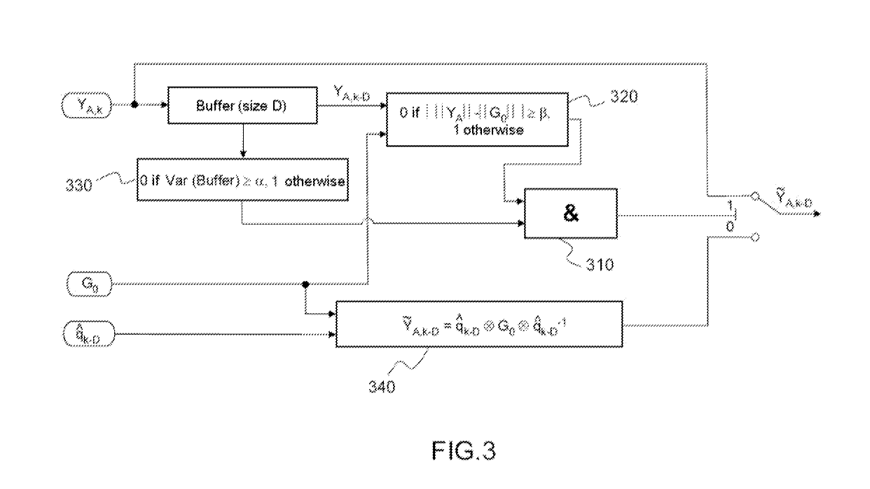

The UDC UnDisturbed Construction modules, 220b for the accelerometer and 230b for the magnetometer, integrate the test functions, as detailed in FIG. 3.

FIG. 3 represents a detail of FIG. 2b.

Represented in the figure is the construction of the UDC module 220b, for UnDisturbed Construction of the measurements of the accelerometer of FIG. 2b.

The measurement input to UDC is Y_{A,k}. The output \tilde{Y}_{A,k} of UDC is the value utilized by the orientation computation algorithm 240, of TRIAD or QUEST type, for example.

A buffer 310 is created to store the samples of the field measurement signal over a D duration identical to the delay introduced on the debiased gyrometer signal.

The disturbance test for the measurement Y_{A,k} consists in providing the 1/0 toggle on the line after the & 320. This toggle consists in effecting the follower filter from the input to the output (1=no disturbance) or the measurement reconstructed by the estimated rotation of the gyrometer alone. This test is for example the conjunction of 2 conditions:
Test 330: the norm of the accelerometer is on average (over the window D) close (<α) to that of gravity, G₀;
Test 340: the variance of the signal over the window D is low (<β).

The UnDisturbed Construction is provided as output by the box 350 through the following formula:

\tilde{Y}_{A,k-D}=\tilde{q}_{k-D} [symbol] G₀ [symbol] \tilde{q}_{k-D}⁻¹

The module 230b for UnDisturbed Construction of the measurements of the magnetometer of FIG. 2b is similar to the module 220b represented in detail in FIG. 3. However, Y_{A,k} is replaced with Y_{M,k}; \tilde{Y}_{A,k} is replaced with \tilde{Y}_{M,k}; G₀ is replaced with H₀.

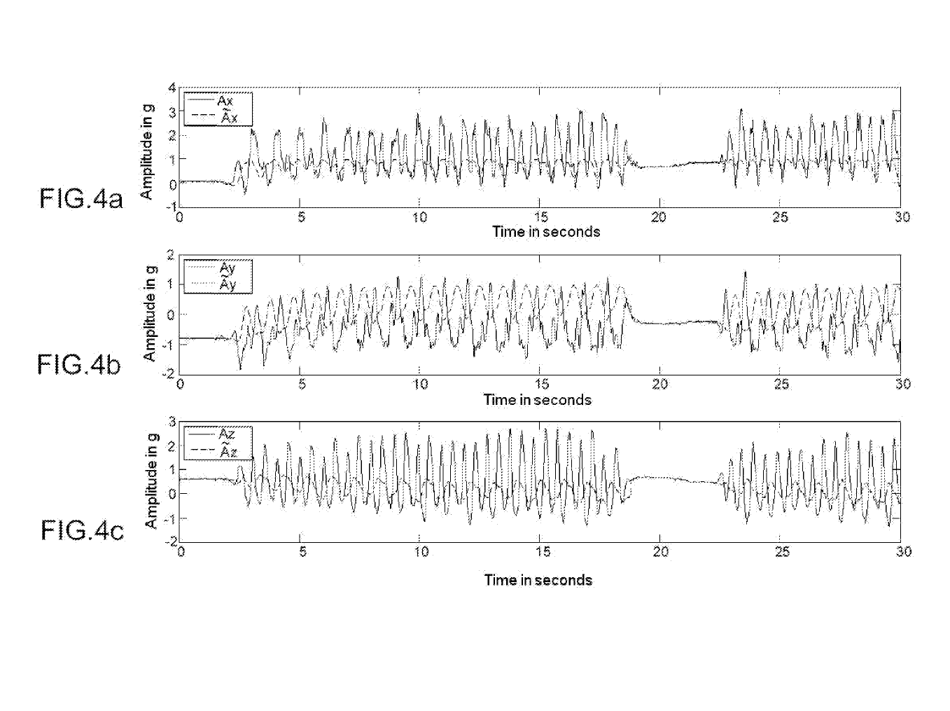

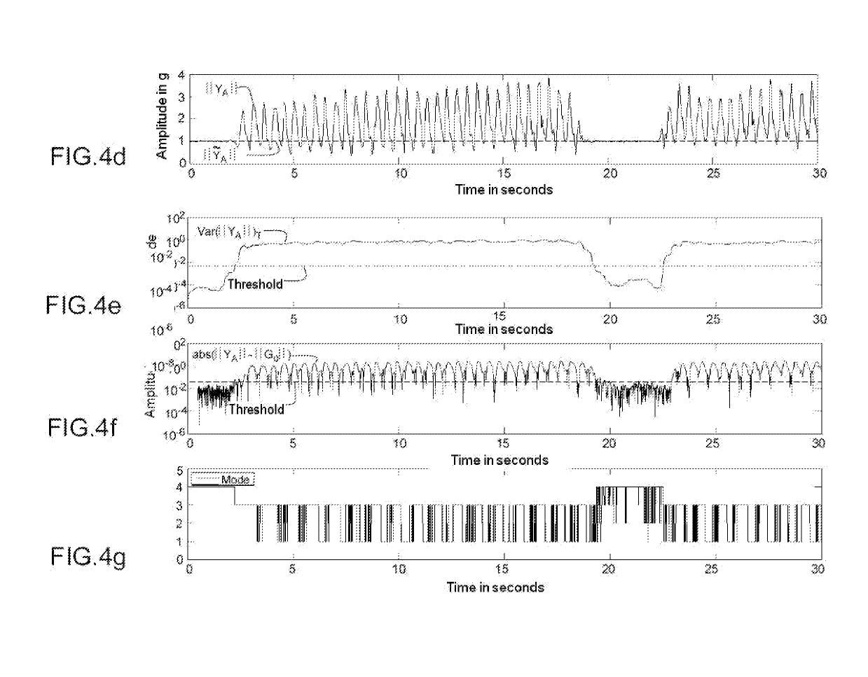

FIGS. 4a to 4g represent measurements carried out on an accelerometer during the implementation of the invention in the architecture of FIG. 2b.

These figures show the effect of replacing the measurements of the accelerometer by their reconstruction based on the integration of the gyrometer. The curves are superimposed while compensating for the delay introduced.

In the presence of disturbances (inherent accelerations), the UDC filter sets its breaker to 1. It is noted that the dashed curves of FIGS. 4a, 4b and 4c (reconstructed on the x, y and z axes) differ during these phases from the solid curves and that they are much less energetic, now comprising only the components in terms of orientation of the accelerometer measurements.

The sensor is shaken, thus adding inherent acceleration beyond gravity but maintaining changes of orientation in the signal. By construction the norm of \tilde{Y}_{A,k} (sum of the squares of the 3 dashed curves along the three axes) remains that of G₀=1 g.

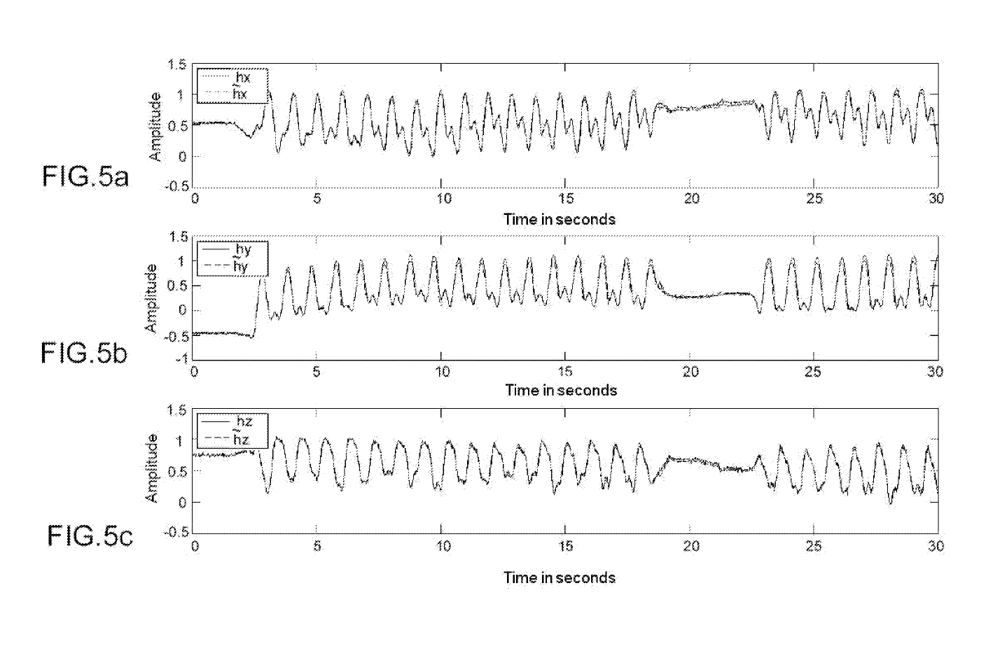

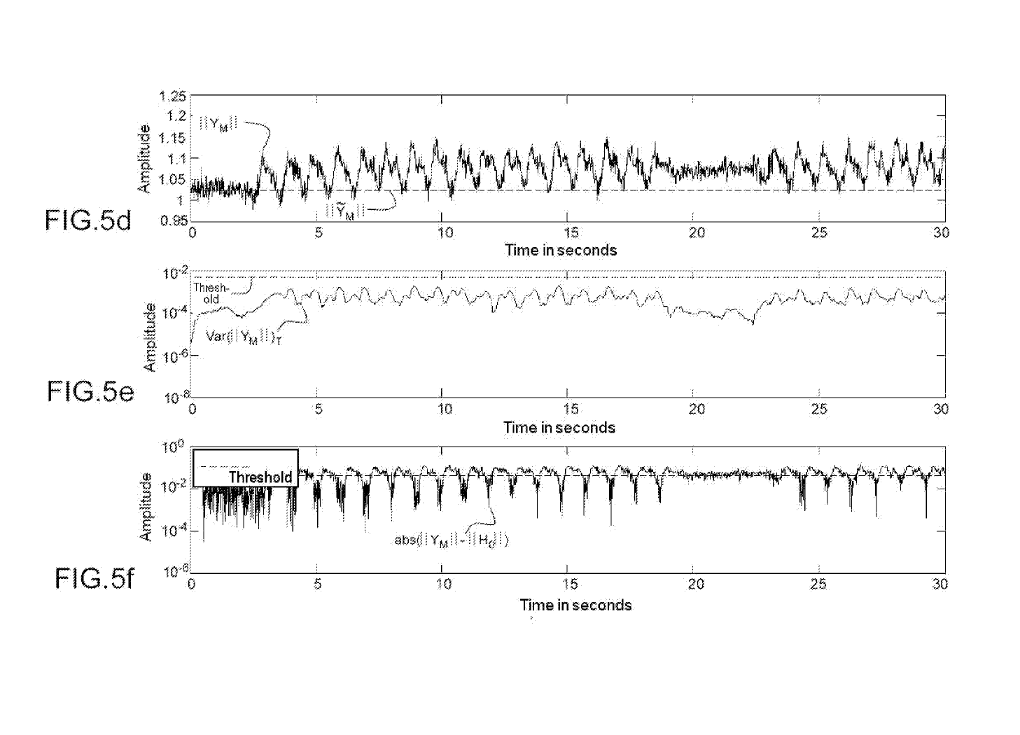

FIGS. 5a to 5f represent measurements carried out on a magnetometer during the implementation of the invention in the architecture of FIG. 2b.

These recordings are performed during the same motion as that represented in FIGS. 4a to 4g. We are interested in the magnetometer. During the motion, the sensor manifestly does not experience big magnetic disturbances, the consequence of which is to observe few differences between the measurement curves and the reconstruction curves.

The examples described hereinabove are given by way of illustration of embodiments of the invention. They do not in any way limit the field of the invention which is defined by the claims which follow.

1. A method for estimating the orientation of an object in space at an instant k using at least one measurement of at least one physical field substantially uniform over time and in space and measurements of the speed of rotation of said object in relation to three space axes, said method comprising:
a first step of detecting the presence of disturbances in the measurements of said at least one physical field, and
a second step of computing a quaternion of orientation of said object in space deduced from at least one representation of the measurements of said at least one physical field as output by the first step,
wherein, when as output of said first step is detected a disturbance of said at least one measurement, said disturbed measurement as output by the first step is combined as input to the second step with a quaternion of orientation of said object computed as output by a third step of integrating a corrected output of the measurement of speed of rotation of the object on the basis of a quaternion of orientation of said object as output by the second step at the instant k−1.

2. The method claim 1, wherein the at least one physical field is the Earth's gravity.

3. The method of claim 1, wherein the at least one physical field is the Earth's magnetic field.

4. The method of claim 1, wherein using at least one measurement of at least one physical field comprises using measurements of at least two physical fields: the Earth's gravity and the Earth's magnetic field.

5. The method of claim 1, wherein using at least one measurement of at least one physical field comprises using measurements of a single physical field and values of a synthetic field that are constructed on the basis of said single physical field, said synthetic field being defined such that it has at least one component orthogonal to said physical field and that its vector product with said physical field is non-zero.

6. The method of claim 5, wherein said physical field is the gravity G₀ and said synthetic field is a vector consisting of a linear combination of said gravity G₀ and of a non-zero vector chosen in a plane orthogonal to G₀.

7. The method of claim 5, wherein said physical field is the Earth's magnetic field H₀ and said synthetic field is a vector consisting of a linear combination of said Earth's magnetic field H₀ and of a non-zero vector chosen in a plane orthogonal to H₀.

8. The method of claim 1, further comprising in the first step, a sub-step of correcting the speed of rotation consisting in deducting from the measurements of said speed of rotation a mean bias determined during a step of position at rest and in substituting it with a corrected speed of rotation.

9. The method of claim 8, wherein the correction sub-step is followed by a step of storing samples of the signal over a duration D.

10. The method of claim 1, wherein the first step of detecting a disturbance in the measurements of said at least one field consists in determining whether the difference of the norm of the measurements of said at least one field and of their reference values is greater than a chosen threshold value.

11. The method of claim 9, wherein the first step of detecting a disturbance in the measurements of said at least one field consists in furthermore determining whether the variance of the samples of the measurement signal for said field that are stored in a buffer of duration D is greater than a chosen threshold value.

12. The method of claim 1, wherein the second step of computing the quaternion of orientation of said object is performed by composition of at least two measurements of physical fields as output by the first step and uses an algorithm of TRIAD type.

13. The method of claim 1, wherein the second step of computing the quaternion of orientation of said object is performed by composition of measurements of more than two measurements of physical fields as output by the first step and uses an algorithm of QUEST type.

14. The method of claim 1, wherein the third step of integrating a corrected output of the measurement of speed of the object on the basis of a quaternion of orientation of said object as output by the second step at the instant k−1 is performed by solving the differential equation:
$${}_{G}^{L ( t )} {q}^{\dot{\_}} = \frac{1}{2} [ \begin{matrix}ω \\ 0\end{matrix} ] ⊗ {}_{G}^{L ( t )} \overline{q}$$

15. The method of claim 1, wherein the estimated quaternion of the object as output by the second step is normalized.

16. An attitude platform for an object in space comprising means for measuring at least one physical field and the speed of rotation of said object in relation to three space axes, said platform comprising a first module for preprocessing at the instant k so as to detect the presence of the at least one physical field and a second module for computing a quaternion of orientation of at least one representation of the orientation of said object computed on the basis of at least one representation of the measurements of said at least one physical field as output by the first module, wherein, when as output of said first module is detected a disturbance of said at least one measurement, said disturbed measurement as output by the first module is replaced as input to the second module by a measurement combined with a quaternion of orientation of said object computed as output by a third module for integrating a corrected output of the measurement of speed of the object on the basis of a quaternion of orientation of said object as output by the second module at the instant k−1.
